(19) United States
(12) Patent Application Publication
(10) Pub. No.: US 2007/0168920 A1
(43) Pub. Date: Jul. 19, 2007

(54) Method of requirements traceability based on a uml model

(76) Inventor: Arnaud Bailleul, Toulouse (FR)

Correspondence Address: LOWE HAUPTMAN GILMAN & BERNER, LLP, 1700 DIAGNOSTIC ROAD, SUITE 300, ALEXANDRIA, VA, 22314, US

(21) Appl. No.: 10/582,900

(22) PCT Filed: Dec. 9, 2004
(86) PCT No.: PCT/EP04/53362

§ 371 Date: Jun. 13, 2006

(30) Foreign Application Priority Data
Dec. 16, 2003 (FR) 0314718

(51) Int. Cl. G06F 9/44

(52) U.S. Cl. 717/104

(57) ABSTRACT

The present invention relates to a method of requirements traceability based on a UML model, and it is characterized in that during the modeling, when creating an element of a model, a requirement is immediately placed on this element, and same is systematically filled in with the upward requirement which has given rise to the creation of this element.

### CROSS-REFERENCE TO RELATED APPLICATIONS

The present Application is based on International Application No. PCT/EP2004/053362, filed on Dec. 9, 2004, which in turn corresponds to FR 03/14718 filed on Dec. 16, 2003, and priority is hereby claimed under 35 USC § 119 based on these applications. Each of these applications are hereby incorporated by reference in their entirety into the present application.

### BACKGROUND OF THE INVENTION

1) Field of the Invention

The present invention pertains to a method of requirements traceability based on a UML model.

2) Description of Related Art

There exist numerous methods of requirements traceability based on a model, but none exists for UML language models. Moreover, these known methods are limited to the code alone, hence they are not transposable to the UML language.

### SUMMARY OF THE INVENTION

The present invention is aimed at a method of requirements traceability based on a model, which can be applied to UML modeling.

The method in accordance with the invention is characterized in that during the modeling, when creating an element of a model, a requirement is immediately placed on this element, and same is systematically filled in with the upward requirement which has given rise to the creation of this element.

### BRIEF DESCRIPTION OF THE DRAWINGS

The present invention will be better understood on reading the detailed description of an embodiment, taken by way of nonlimiting example and illustrated by the appended drawing, in which:

FIG. 1 is a view of a graphics interface of a “RHAPSODY” tool showing a requirement of a UML model, such as used by the present invention,

FIG. 2 is a view of the graphics interface of FIG. 1, showing an exemplary constraint attachment, in accordance with the method of the invention,

FIG. 3 is a view of the graphics interface of FIG. 1, showing an exemplary attachment of a UML requirement, in accordance with the method of the invention, and

FIG. 4 is a chart showing an exemplary chaining of activities between the “RHAPSODY” and “DOORS” tools, in accordance with the method of the invention.

### DETAILED DESCRIPTION OF THE INVENTION

It is known that the creation of a UML requirement always follows a modeling activity, but one should definitely not create the requirements, then model what is specified in these requirements, since this would inevitably lead to poor use of UML and of the concept of object.

It is advisable, each time that a requirement which refines one or more upward requirements is created, to systematically fill in the “UpwardReq:” tag with the identifier of these upward requirements. Thus, the traceability of the requirements is managed at the time of their creation and not a posteriori on the set of requirements.

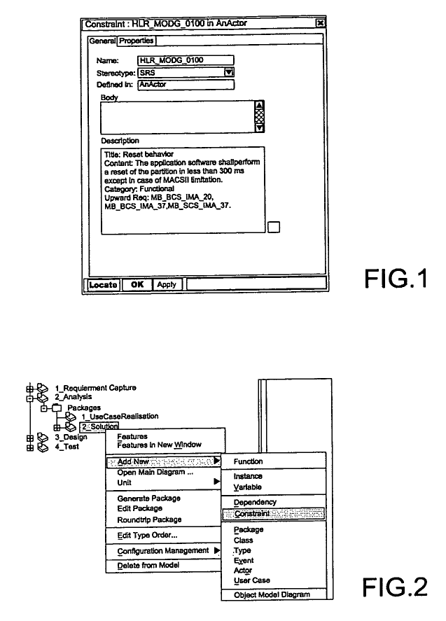

A requirement is represented in the UML model (with the “RHAPSODY” modeling tool from the company I-LOGIX) by a UML constraint called a “UML Requirement”. An example thereof has been represented in FIG. 1.

All the UML Requirements must be defined in the same manner according to the following model (or “template”):
the “Name” field (name of the UML Requirement) must contain the identifier of the requirement. This identifier must make it possible to identify the level of the requirement. If the requirement is high-level, the identifier must begin with “HLR_”, and if the requirement is low-level, the identifier must begin with “LLR_”.
the “Stereotype” field must contain the specification level of the requirement (SSS, SRS, etc.). Specifically, the requirements defined for these various specification levels are all present in the same UML model. Filling in this stereotype field is hence the only means to differentiate the requirements as a function of their specification level and hence to identify toward which “DOORS” module (the DOORS tool is a requirements management tool from the company TELELOGIC) they must be redirected.
the “Description” field (description of the UML Requirement) must contain the following tags:
   “Title:”, followed by the title of the requirement,
   “Content:”, followed by the text of the requirement, “Upward Req:” (upward request), followed by the list of the identifiers of the upward requirements from which this requirement stems. The identifiers must be separated by a comma (“,”).

It will be pointed out that the set of requirements management attributes, such as defined in the DOORS process, do not form part of the UML model. The activity which consists in filling in these attributes is performed directly under DOORS, following the uploading of the UML requirements under DOORS.

The attachment of the Requirements is done in the following manner. In the Rhapsody tool, the only means to associate a UML Requirement) with an element of the model is to attach it to this element by using the “Add New/Constraint” function, as represented in the example of FIG. 2 (for the requirement “Solution”).

This attachment function is available on all the elements of a model (“Package”, Class, Operation, Party, Case of use, State machine, State, etc).

Currently, the UML 1.4 standard defines that a constraint (a UML Requirement) can be attached to several UML elements, but RHAPSODY does not allow it. Consequently, when creating a UML Requirement) which has repercussions on several elements of the model, said requirement is attached to the common element containing the set of elements on which the requirement has repercussions.

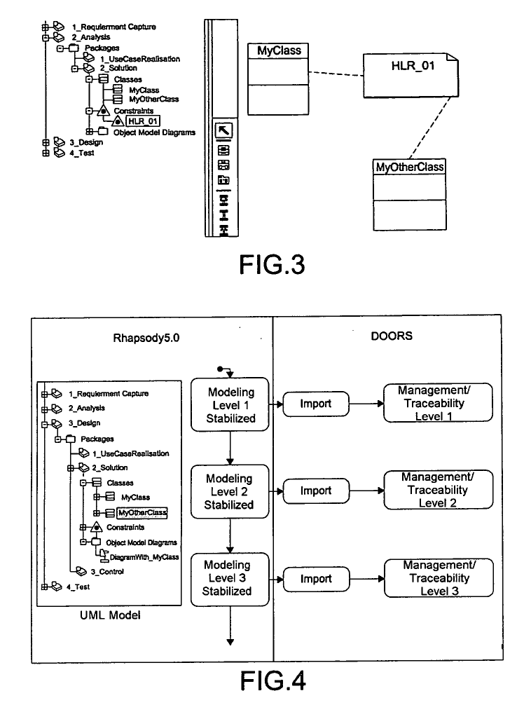

Described below in a nonlimiting manner are two examples of such an attachment:
if two classes of one and the same “package” are relevant to the same UML Requirement, then this UML Requirement will be attached to the “package” containing the two classes,
if a UML Requirement) has repercussions on three methods of one and the same class, then this UML Requirement) will be attached to the class. We have represented in FIG. 3 an example of such an attachment of UML Requirement (high-level Requirement “HLR_{—}01” with two classes 3MyClass” and “MyOtherClass”).

According to another characteristic of the invention pertaining to the incidence on the persistence of the UML Requirements, when an element of the model is deleted, all the UML Requirements attached to this element (and to all the elements attached to this element) are likewise deleted.

According to yet another characteristic of the invention, the UML Requirements are exported under DOORS, following a step of UML modeling, which corresponds in general to a given specification level, a model containing a set of UML elements and of UML Requirements is obtained, stereotyped with the corresponding specification level. When the UML model has attained a stable state, it is possible to then import the UML model under DOORS so as to perform the activities of management and requirements traceability.

Diagrammatically represented in FIG. 4 is an exemplary chaining of exportation activities from RHAPSODY to DOORS. In this figure, the RHAPSODY and DOORS tools have been represented side by side. For the first, we have represented the tree of a UML model and three successive development steps each having attained a stable modeling state, these steps being respectively referenced Level 1 to Level 3. As the development proceeds, the successive models are imported into DOORS and immediately the management and the traceability of their requirements is undertaken in DOORS in accordance with the method of the invention, as set forth above.

1. A method of requirements traceability based on a UML model, comprising the steps of: during the modeling, a graphics interface is used when creating an element of a model,
placing a requirement immediately on the element in this graphics interface and the element is systematically filled in with the upward requirement which has given rise to the creation of this element.

2. The method as claimed in claim 1, comprising the steps of: when creating a UML Requirement which has repercussions on several elements of the model, attaching said requirement to the common element containing the set of elements on which the requirement has repercussions.

3. The method as claimed in claim 1, comprising the steps of: when an element of the model is deleted, all the UML Requirements attached to this element are likewise deleted.

4. The method as claimed in claim 3, wherein all the UML Requirements attached to all the elements attached to said element are likewise deleted.

5. The method as claimed in claim 1, comprising the steps of: the UML Requirements are exported to the “DOORS” requirements management tool so as to ensure therein their management and their traceability.

6. The method as claimed in claim 5, comprising the steps of: the UML Requirements are exported to DOORS, in the course of the development of the model, each time that this model has attained a stable state.

7. The method as claimed in claim 2, wherein when an element of the model is deleted, all the UML Requirements attached to this element are likewise deleted.

8. The method as claimed in claim 2, wherein the UML Requirements are exported to the DOORS requirements management tool so as to ensure therein their management and their traceability.

9. The method as claimed in claim 3, wherein the UML Requirements are exported to the DOORS requirements management tool so as to ensure therein their management and their traceability.

10. The method as claimed in claim 4, wherein the UML Requirements are exported to the DOORS requirements management tool so as to ensure therein their management and their traceability.
